(19) United States
(12) Patent Application Publication
(10) Pub. No.: US 2009/0028071 A1
(43) Pub. Date: Jan. 29, 2009

(54) VOICE CONFERENCE SYSTEM AND PORTABLE ELECTRONIC DEVICE USING THE SAME

(75) Inventor: HSU-HONG FENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/967,101

(22) Filed: Dec. 29, 2007

(30) Foreign Application Priority Data
Jul. 25, 2007 (CN) 200710075295.9

(51) Int. Cl. H04M 3/56; H04B 1/38

(52) U.S. Cl. 370/260; 455/557

(57) ABSTRACT

A voice conference system includes a wireless transceiver (11a), an audio input/output module (12), a digital signal processor (16) electronically connected with the audio input/output module, a telecom module (18) electronically connected with the wireless transceiver and the digital signal processor, and an application processor (14) electronically connected with the wireless transceiver and the digital signal processor. The wireless transceiver is configured for sending and receiving signals. A sound input into the audio input/output module is sent through the digital signal processor, the application processor and the wireless transceiver, or through the digital signal processor, the telecom module and the wireless transceiver. A sound input into the wireless transceiver is sent through the telecom module and the digital signal processor to the audio input/output module, or is sent through the application processor and the digital signal processor to the audio input/output module.

### BACKGROUND OF THE INVENTION

1. Field of the Invention

The present invention generally relates to communication systems, particularly to a voice conference system and a portable electronic device using the same.

2. Discussion of the Related Art

With the development of wireless communication and information processing technologies, portable electronic devices, such as mobile phones and personal digital assistants (PDAs), are now in widespread use. These portable electronic devices enable consumers to enjoy high technology services, almost anytime and anywhere. Mobile communication system and network communication system are considered, as two indispensable communication platforms in information exchange.

Conventionally, a mobile phone acts as a terminal of the mobile communication system, and only support the services provided by the mobile communication system. The services are provided by a telecom provider. However, these services are restricted to the agreement between the provider and the subscriber.

Due to the popular demand of wireless communication device, an intelligent mobile phone usually supports more than one wireless communication interface, such as Wifi (Wireless Fidelity), WiMAX (World Interoperability for Microwave Access), and so on. In addition, the intelligent mobile phone also supports TCP/IP (Transmission Control Protocol) and a third-party application running on the platform thereof. For example, VoIP (Voice over Internet Protocol), a routing of voice conversations over the Internet or through any other IP-based network, has been applied in the intelligent mobile phone. A typical advantage of VoIP is it has a very low cost, and the communication cost of subscriber is low.

However, because the VoIP data packets may have to pass through networks having different protocols, the data may get corrupted and the person on the other end of the VoIP connection may not be able to receive the voice fluently.

Therefore, an independent VoIP-telecom voice conference system of network protocol and a portable electronic device using the same are desired in order to overcome the above-described problems.

### SUMMARY

In one aspect, a voice conference system comprises a wireless transceiver, an audio input/output module, a digital signal processor electronically connected with the audio input/output module, a telecom module electronically connected with the wireless transceiver and the digital signal processor, and an application processor electronically connected with the wireless transceiver and the digital signal processor. The wireless transceiver is configured for sending and receiving signals. A sound input into the audio input/output module is sent through the digital signal processor, the application processor and the wireless transceiver, or through the digital signal processor, the telecom module and the wireless transceiver. A sound input into the wireless transceiver is sent through the telecom module and the digital signal processor to the audio input/output module, or is sent through the application processor and the digital signal processor to the audio input/output module.

In another aspect, a portable electronic device comprises a wireless transceiver, an audio input/output module, a digital signal processor electronically connected with the audio input/output module, a telecom module electronically connected with the wireless transceiver and the digital signal processor, and an application processor electronically connected with the wireless transceiver and the digital signal processor. The wireless transceiver is configured for sending and receiving signals. A sound input into the audio input/output module is sent through the digital signal processor, the application processor and the wireless transceiver, or through the digital signal processor, the telecom module and the wireless transceiver. A sound input into the wireless transceiver is sent through the telecom module and the digital signal processor to the audio input/output module, or is sent through the application processor and the digital signal processor to the audio input/output module.

Other advantages and novel features of the embodiments will become more apparent from the following detailed description thereof when taken in conjunction with the accompanying drawings.

### BRIEF DESCRIPTION OF THE DRAWINGS

Many aspects of the voice conference system and portable electronic device using the same can be better understood with reference to the following drawings. Drawings are not necessarily drawn to scale, the emphasis instead being placed upon clearly illustrating the principles of the present voice conference system and portable electronic device using the same. Moreover, in the drawings, like reference numerals designate corresponding parts throughout the several views.

FIG. 1 is a system architecture schematic of a portable electronic device having a voice conference system, in accordance with a present embodiment.

### DETAILED DESCRIPTION OF THE EMBODIMENTS

The present voice conference system is suitable for portable electronic devices with communication function, such as mobile phones, PDAs, and so on.

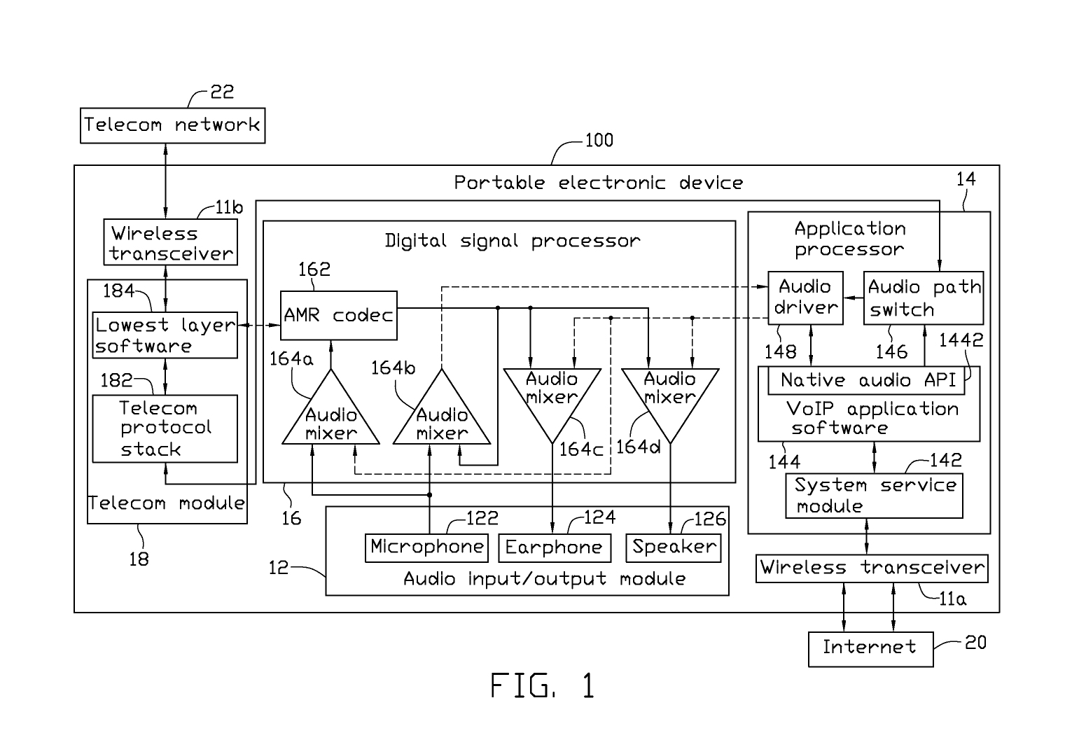

Referring to FIG. 1, a voice conference system (not labeled) includes two wireless transceivers 11a and 11b, an audio input/output module 12, an application processor 14, a digital signal processor 16 and a telecom module 18. The transceiver 11a is electronically connected with the application processor 14 which is electronically connected with the digital signal processor 16 and telecom module 18. The transceiver 11b is electronically connected with the telecom module 18 which is electronically connected with the digital signal processor 16 which is electronically connected with the audio input/output module 12. The wireless transceiver 11a and 11b are provided for receiving and sending signals from and to Internet 20 and telecom network 22. The wireless transceivers 11a and 11b can respectively be an antenna. The audio input/output module 12 includes a plurality of audio hardware. The plurality of audio hardware includes a microphone 122 provided for inputting voice signals, an earphone 124 and a speaker 126 provided for outputting voice signals.

The application processor 14 includes a system service module 142, a VoIP application software 144, an audio path switch 146 and an audio driver 148. The application processor 14 is provided for compiling and coding a signal sent from Internet 20 in the operation platform of the portable electronic device 100. The system service module 142 includes a TCP/IP protocol stack of the application processor 14. The VoIP application software 144 is configured with a function of VoIP communication, such as Skype, Microsoft Network messenger (MSN), tencent QQ, and so on. The VoIP application software 144 is provided for coding and decoding an audio signal. The VoIP application software 144 includes a native audio API (application programming interface) 1442 for providing an audio service in system, such as broadcasting and recording sounds.

The audio path switch 146 is provided for receiving control signals from telecom module 18 and VoIP application software 144, and for sensing a state of the audio hardware. The audio driver 148 is configured for switching an audio hardware to another hardware, and activating the required audio hardware, according to the sensed result of the audio path switch 146. The audio driver 148 can also be provided to process audio signals, such as eliminating a noise.

The digital signal processor 16 includes an AMR (adaptive multi-rate) codec 162 and a plurality of audio mixer 164a, 164b, 164c, and 164d electronically connected with the AMR codec 162. The AMR codec 162 is provided for coding and decoding an audio signal. The plurality of audio mixers 164a, 164b, 164c, and 164d are provided for audio mixing in the digital signal processor 16.

The telecom module 18 includes a telecom protocol stack 182 and a lowest layer software 184. The telecom module 18 is configured for controlling the connection of a communication according to the telecom protocol stack 182 and for communicating with the telecom network 22. The lowest layer software 184 is provided for separating one signal into a control signal and an audio signal.

When user A communicates with user B through Internet 20 and user C through telecom network 22, that is, user A, B and C has a conference call together. During the conference call, sound of each user is respectively sent to each other.

A signal flow of the communication process can be described in detail as follows. A sound of user A is respectively sent to user B and user C. That is, the sound of user A can either be transmitted to the audio driver 148 through the microphone 122 and the audio mixer 164b, or through the microphone 122. The audio driver 148 communicates with the VoIP application software 144 and sends the received sound of user A to the VoIP application software 144. The VoIP application software 144 compresses the sound of user A into a compressed voice coding and sends the compressed voice coding to the system service module 142. The system service module 142 packs the received compressed voice coding and sends it to Internet 20 through the wireless transceiver 11a, and then user B of Internet 20 receives the sound of user A.

Meanwhile, a sound of user A can either be sent to the AMR codec 162 through the microphone 122 and audio mixer 164a, or through the microphone 122. The AMR codec 162 encodes the sound of user A and sends the encoded sound to the lowest layer software 184 of the telecom module 18. The lowest layer software 184 separates the encoded sound into a control signal and an audio signal according to the telecom protocol stack 182. The audio signal is sent to the telecom network 22, so that user C can receive the voice of user A.

The sounds of user B and user C are sent to user A simultaneously. A sound of user B is sent to the system service module 142 of the application processor 14 after being packed by the wireless transceiver 11a. The system service module 142 encodes the sound of user B and compresses the encoded sound of user B into a compressed voice coding, and then sends the compressed voice coding to the VoIP application software 144. The VoIP application software 144 decompresses the received compressed voice coding to a voice coding. A VoIP state information is sent to the audio path switch 146 by the VoIP application software 144 through the native audio API 1442. The audio path switch 146 judges whether or not continue transmitting the voice coding according to the state of the microphone 124 and speaker 126. Then the audio path switch 146 sends a control instruction to the audio driver 148. If the microphone 124 and speaker 126 are in use, and then the voice coding cannot be sent. If both the microphone 124 and the speaker 126 are not in use, the voice coding of user B can either be sent to audio mixer 164c or audio mixer 164d by the audio driver 148.

A sound of user C is sent to the telecom module 18 passing through the wireless transceiver 11b. The lowest layer software 184 of the telecom module 18 separates the received sound into a control signal and an audio signal, and sends the audio signal to the AMR codec 162. The AMR codec 162 decodes the received audio signal and sends the decoded audio signal to the audio mixer 164c or audio mixer 164d.

Similar to the process described above, the sounds of user A and user B are respectively transmitted to user C. The sound of user A transmitted to the audio mixer 164a through the microphone 122. The sound of user B is sent to the system service module 142 of the application processor 14 after packed by the wireless transceiver 11a. The system service module 142 encodes the sound of user B and compresses the encoded sound of user B into a compressed voice coding, and then sends the compressed voice coding to the VoIP application software 144. The VoIP application software 144 decompresses the received compressed voice into a voice coding and sends the voice coding to the audio driver 148 passing through the native audio API 1442. The audio driver 148 sends the received voice coding of user B to audio mixer 164a.

The voice coding of user A and the voice coding of user B are mixed by the audio mixer 164a and sent to the AMR codec 162. The AMR codec 162 encodes the received voice coding and sends the encoded voice coding to the telecom module 18. The lowest layer software 184 of the telecom module 18 separates the encoded voice coding into a control signal and an audio signal, and sends the audio signal to the telecom network 22, and then user C can receive the sounds of both user A and user B simultaneously.

The sounds of user A and user C are respectively transmitted to user B. A sound of user C is sent to the telecom module 18 passing through the wireless transceiver 11b. The lowest layer software 184 of the telecom module 18 separates the received sound into a control signal and an audio signal, and sends the audio signal to the AMR codec 162. The AMR codec 162 decodes the received audio signal and sends the decoded audio signal to the audio mixer 164b. The sounds of user A and user B are mixed by the audio mixer 164b and sent to the audio driver 148.

The audio driver 148 judges whether the received mixed sound should or not be continuously transmitted according to a VoIP state of the VoIP application software 144. Then the audio path switch 146 sends a control instruction to the audio driver 148. If the VoIP application software 144 is in use, the received mixed sound cannot be transmitted, and the audio driver 148 generates a busy tone. If VoIP application software 144 is not in use, the audio driver 148 sends the received mixed sounds to the VoIP application software 144. The VoIP application software 144 decompresses the received mixed sound into a voice coding and sends the voice coding to the system service module 142. The system service module 142 compresses the received voice coding into a compressed voice coding and sends the compressed voice coding to Internet 20 passing through the wireless transceiver 11a, and then user B of Internet 20 can receive the sounds of user A and user B simultaneously. As described above, each user in the three-way calling conference can receive the sound of the other users, and a voice conference is implemented.

The voice conference process can be described in brief as follows. When user A of the portable electronic device 100 has a VoIP call with user B of Internet 20 and builds a GSM call with user C of the telecom network 22 at the same time, both the VoIP call and the GSM call can be combined into a conference call.

During the conference call, the sound of user A is sent through the microphone 122 to the VoIP application software 144 and the telecom module 18, and then is sent by the wireless transceiver 11a and the wireless transceiver 11b respectively to Internet 20 and the telecom network 30, and then the sound of user A is sent to user B and user C.

When user B and user C are speaking, the sounds of user B and user C are sent to the portable electronic device 100 respectively through Internet 20 and telecom network 22. After the sounds of user B and user C are mixed by the audio mixer 164c or 164d, the mixed sounds of user B and user C are sent to the earphone 124 or the speaker 126, for allowing user A to hear the sounds of user B and user C.

Meanwhile, the voices of user A and user B are mixed by the audio mixer 164a in the portable electronic device 100, and sent through the telecom module 18 and wireless transceiver 11b to the telecom network 22, for allowing user C to hear the sounds of user A and user B. The sounds of user A and user C are mixed by the audio mixer 164b in the portable electronic device 100, and sent to Internet 20 by the VoIP application software 144, for allowing user B to hear the sounds of user A and user C. As a result, each user in the 3-way calling conference can receive the sound of the other users, and a voice conference is implemented.

User B of the telecom network 22 and user C of Internet 20 can communicate directly with each other. The sound of user B is sent to the system service module 142 of the application processor 14 after packed by the wireless transceiver 11a. The system service module 142 encodes the sound of user B and compresses the encoded sound of user B into a compressed voice coding, and then sends the compressed voice coding to the VoIP application software 144.

The VoIP application software 144 decompresses the received compressed voice into a voice coding and sends the voice coding to the audio path switch 146 through the native audio API 1442. The audio path switch 146 detects the state of the telecom module 18. If the telecom module 18 is free, the audio path switch 146 connects with the telecom protocol stack 182, and transmits the voice coding to the telecom protocol stack 182. The telecom protocol stack 182 sends a control signal and the voice coding of user B to the lowest layer software 184. The lowest layer software 184 processes the received voice coding, and sends it to the telecom network 22 through the wireless transceiver 11b, for allowing user C to hear the sound of user B.

The sound of user C is sent to the telecom module 18 through the wireless transceiver 11b. The lowest layer software 184 of the telecom module 18 processes the received sound. The telecom module 18 sends the received sound to the audio path switch 146 according to the telecom protocol stack 182. The audio path switch 146 judges whether or not continue transmitting the sound according to the state of the VoIP application software 144. Then the audio path switch 146 sends a control instruction to the audio driver 148. If the VoIP application software 144 is in use, the voice signal cannot be sent. If the VoIP application software 144 is not in use, the audio driver 148 sends the sound of user C to the VoIP application software 144. The VoIP application software 144 compresses the sound into a compressed voice coding and sends the compressed voice coding to the system service module 142. The system service module 142 packs the received compressed voice coding and sends it to Internet 20 through the wireless transceiver 11a, for allowing user B to hear the sound of user C.

As described above, the portable electronic device 100 and the voice conference system thereof can complete a voice conference between VoIP and a telecom call (such as GSM communication) independent of network protocol of a telecom call, without the support from the providers. The portable electronic device 100 is located as a router between two different networks, by encoding, decoding and audio mixing functions thereof.

It should be understood, the wireless transceiver 11a and wireless transceiver 11b can be a single wireless transceiver. The single wireless transceiver can receive signals from Internet 20 and the telecom network 22. In addition, one of the earphone 124 and the speaker 126 can be omitted.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A voice conference system comprising:
a wireless transceiver configured for sending and receiving signals;
a telecom module electronically connected with the wireless transceiver;
a digital signal processor electronically connected with the telecom module;
an audio input/output module electronically connected with the digital signal processor; and
an application processor electronically connected with the wireless transceiver and the digital signal processor;
wherein a sound input into the audio input/output module is sent through the digital signal processor, the application processor and the wireless transceiver, or through the digital signal processor, the telecom module and the wireless transceiver; a sound input into the wireless transceiver is sent through the telecom module and the digital signal processor to the audio input/output module, or is sent through the application processor and the digital signal processor to the audio input/output module.

2. The voice conference system as claimed in claim 1, wherein the wireless transceiver is an antenna.

3. The voice conference system as claimed in claim 1, wherein the audio input/output module includes a plurality of audio hardware, the audio hardware includes a microphone provided for inputting a voice signal and an earphone provided for outputting a voice signal.

4. The voice conference system as claimed in claim 3, wherein the audio input/output module further includes a speaker provided for amplifying a volume of an output audio signal.

5. The voice conference system as claimed in claim 3, wherein the application processor includes a system service module, a VoIP application software, an audio path switch and an audio driver, the system service module including a TCP/IP protocol stack, the VoIP application software being provided for instant communication in Internet, the VoIP application software including a native audio application programming interface; the audio path switch configured for sensing a state of the audio hardware, and receiving control signals from the telecom module and the VoIP application software; the audio driver being provided for switching and driving the audio hardware according to the sensed result of the audio path switch.

6. The voice conference system as claimed in claim 5, wherein the digital signal processor includes an adaptive multi-rate codec and at least one audio mixer electronically connected with the adaptive multi-rate codec.

7. The voice conference system as claimed in claim 6, wherein the telecom module includes a telecom protocol stack and a lowest layer software, the telecom module configured for deciding whether to connect with the application processor according to the telecom protocol stack and for communicating with the telecom network if the telecom module is connected to the application processor; the lowest layer software configured for separating a signal into a control signal and an audio signal.

8. A portable electronic device comprising:
a wireless transceiver configured for sending and receiving signals;
a telecom module electronically connected with the wireless transceiver;
a digital signal processor electronically connected with the telecom module;
an audio input/output module electronically connected with the digital signal processor; and
an application processor electronically connected with the wireless transceiver and the digital signal processor;
wherein a sound input into the audio input/output module is sent through the digital signal processor, the application processor and the wireless transceiver, or through the digital signal processor, the telecom module and the wireless transceiver; a sound input into the wireless transceiver is sent through the telecom module and the digital signal processor to the audio input/output module, or is sent through the application processor and the digital signal processor to the audio input/output module.

9. The portable electronic device as claimed in claim 8, wherein the wireless transceiver is an antenna.

10. The portable electronic device as claimed in claim 8, wherein the audio input/output module includes a plurality of audio hardware, the audio hardware includes a microphone provided for inputting a voice signal and an earphone provided for outputting a voice signal.

11. The portable electronic device as claimed in claim 10, wherein the audio input/output module further includes a speaker provided for amplifying a volume of an output audio signal.

12. The portable electronic device as claimed in claim 10, wherein the application processor includes a system service module, a VoIP application software, an audio path switch and an audio driver, the system service module including a TCP/IP protocol stack, the VoIP application software being provided for instant communication in Internet, the VoIP application software including a native audio application programming interface; the audio path switch configured for sensing a state of the audio hardware, and receiving control signals from telecom module and VoIP application software; the audio driver is provided for switching and driving the audio hardware according to the sensed result of the audio path switch.

13. The portable electronic device as claimed in claim 12, wherein the digital signal processor includes an adaptive multi-rate codec and at least one audio mixer electronically connected with the adaptive multi-rate codec.

14. The portable electronic device as claimed in claim 13, wherein the telecom module includes a telecom protocol stack and a lowest layer software, the telecom module deciding whether to connect with the application processor according to the telecom protocol stack and for communicating with the telecom network if the telecom module is connected to the application processor; the lowest layer software configured for separating a signal into a control signal and an audio signal.
